(19) United States
(12) Patent Application Publication
(10) Pub. No.: US 2007/0237513 A1
(43) Pub. Date: Oct. 11, 2007

(54) Photographing method and photographing apparatus

(75) Inventors: Masahiko Sugimoto, Asaka-shi (JP); Atsushi Misawa, Asaka-shi (JP); Hiroshi Tanaka, Tokyo (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 11/727,331

(22) Filed: Mar. 26, 2007

(30) Foreign Application Priority Data
Mar. 27, 2006 (JP) 085459/2006

(51) Int. Cl. G03B 13/34

(52) U.S. Cl. 396/123

(57) ABSTRACT

Power consumption of a photographing apparatus during detecting a face and automatically focusing on the face is reduced. An image representing a face is detected from images taken through an imaging lens, which has an automatic focusing unit for automatically adjusting a point of focus to focus on a detected face. When the image representing a face is detected, whether or not a photographing condition at the time when the image representing the face is taken satisfies an appropriate photographing condition is determined. If it is determined that the photographing condition satisfies the appropriate photographing condition, the automatic focusing unit is controlled to carry out the focusing operation to focus on the face. If it is determined that the photographing condition does not satisfy the appropriate photographing condition, the automatic focusing unit is controlled to not carry out the focusing operation.

### BACKGROUND OF THE INVENTION

1. Field of the Invention

The present invention relates to a photographing method and a photographing apparatus, which take a subject's image focused on an imaging surface through an imaging lens having an automatic focusing means.

2. Description of the Related Art

Digital cameras, which detect an image representing a human face from taken images to automatically focus on the subject's face or to automatically change the zoom magnification so that the area representing the face in the detected image is enlarged, have been known (see Japanese Unexamined Patent Publication No. 2004-320286).

For use with such digital cameras, a method for automatically focusing on a subject's face, in which images for photographing conditions setting are taken when the shutter button is half pressed, and an image representing the face is detected from the images to focus on the face, has been known.

In the above method, a large amount of processing is carried out after the shutter button is half-pressed and before the subject's face is focused on, and therefore, a long waiting time is required before photographing for recording the photographed image (which may hereinafter be referred to as “actual photographing”) is enabled. Therefore, a digital camera using the following “continuous face detection method”, which reduces the waiting time, has been considered. In the digital camera using the continuous face detection method, face detection for detecting an image representing a face from the taken images is constantly carried out even when the shutter button is not touched. Then, when a face is detected, the face is automatically focused. According to this method, the digital camera can be operated so that the subject's face is always focused regardless of the operational state of the shutter button. This reduces the waiting time. When the shutter button is fully pressed to carry out actual photographing, the subject face has substantially been focused.

Further as a mechanism for focusing on the face, an AF (automatic focus) mechanism using a contrast detection method has been known. In the contrast detection AF mechanism, images are taken while the focusing lens group is moved within its operation range, and the image having the maximum contrast, i.e., having the maximum focus evaluation value, is found from the images. Then, the focusing lens group is set at the position where the image with the maximum contrast has obtained (see Japanese Unexamined Patent Publication No. 2004-320286).

Although the continuous face detection method is advantageous in the short waiting time before the actual photographing of the subject's face, automatic focusing operation is repeatedly carried out in the constantly-performed face detection process, and therefore, power consumption thereof is larger than those of other processes. Therefore, there is a demand for reduction of power consumption in the continuous face detection method.

### SUMMARY OF THE INVENTION

In view of the above-described circumstances, the present invention is directed to provide a photographing method and a photographing apparatus that allow reduction of power consumption during the automatic focusing operations.

An aspect of the photographing apparatus of the invention is a photographing apparatus for photographing an image of a subject focused on an imaging surface through an imaging lens provided in the photographing apparatus, which has an automatic focusing means for automatically adjusting the point of focus to focus on a detected face. The photographing apparatus includes: a storing means for storing discrimination information for discriminating a face; a detecting means for detecting, based on the discrimination information, an image representing a face from images taken through the imaging lens; a determining means for determining, when the image representing a face is detected by the detecting means, whether or not a photographing condition of the photographing apparatus satisfies an appropriate photographing condition; and a controlling means for exerting control such that, if it is determined by the determining means that the photographing condition of the photographing apparatus satisfies the appropriate photographing condition, the automatic focusing means carries out a focusing operation to focus on the face, and if it is determined that the photographing condition of the photographing apparatus does not satisfy the appropriate photographing condition, the automatic focusing means does not carry out the focusing operation.

The point of focus herein refers to a position of the subject (object point) corresponding to an image (image point) correctly focused on the imaging surface. The image of the subject positioned at the point of focus of the imaging lens is focused on the imaging surface.

The face may be a human face.

The appropriate photographing condition may be that the position and the size of the image representing a face within images acquired by photographing the face stay unchanged. It should be noted that the condition where the position and the size of the image representing a face stay unchanged is not limited to a state where the position and the size of the image representing a face is completely fixed, and includes a state where changes in the position and the size of the image representing a face are small enough that no blur is observed in the image representing a face acquired by photographing the face.

The appropriate photographing condition may be that the angle of view of the imaging lens is fixed. It should be noted that the condition where the angle of view is fixed is not limited to a state where the angle of view is completely fixed, and includes a state where changes in the angle of view are small enough that no blur is observed in the image representing a face acquired by photographing the face.

The appropriate photographing condition may be that the photographing apparatus is stationary. It should be noted that the condition where the photographing apparatus is stationary is not limited to a state where the photographing apparatus is completely stationary, and includes a state where changes in the position of the photographing apparatus are small enough that no blur is observed in the image representing a face acquired by photographing the face.

The appropriate photographing condition may be that the images taken through the imaging lens have a constant focus evaluation value. It should be noted that the condition where the images have a constant focus evaluation value includes a state where changes in the focus evaluation value from image to image are within a range of ±5%.

The appropriate photographing condition may be that an amount of light received on the imaging surface stays unchanged. It should be noted that the condition where the amount of light received on the imaging surface stays unchanged is not limited to a state where the amount of light received on the imaging surface is completely fixed, and includes a state where changes in the amount of received light are small enough that no defect is observed when photographing the face. The area from which the amount of received light is obtained may, for example, be the entire imaging surface, an area of interest on the imaging surface, or sectional areas of the imaging surface.

The appropriate photographing condition may be that values representing colors of the taken images stay unchanged. It should be noted that the condition where values representing colors of the taken images stay unchanged is not limited to a state where the values representing colors do not change at all, and includes a state where changes in the values representing colors are small enough that no defect is observed when photographing the face. The value representing colors of each taken image may, for example, be an integration value of the R, G and B signals representing the colors of the image. Alternatively, the value representing colors of the image may be a white balance value. Further, the area from which the value representing colors of the image is obtained may be the entire imaging surface, an area of interest on the imaging surface, or sectional areas of the imaging surface.

The photographing apparatus may further include a subject movement detecting means for detecting movement of the subject and outputting the result of the detection, and the appropriate photographing condition may be that the output from the subject movement detecting means indicates that the position of the subject stays unchanged.

The appropriate photographing condition may be that a photographing mode of the photographing apparatus is set to one of a face detection mode, a person photographing mode, a self-timer photographing mode and a self-photographing mode. It should be noted that the person photographing mode is a photographing mode assuming that the subject is a person(s).

The appropriate photographing condition may be that an amount of remaining energy accumulated in a battery for driving the automatic focusing means is not more than a preset threshold value. The appropriate photographing condition may be that an amount of remaining energy accumulated in a battery for driving the automatic focusing means is not less than a preset threshold value. The threshold value may be 10% of the maximum amount of energy that can be accumulated in the battery.

An aspect of the photographing method of the invention is a photographing method for photographing an image of a subject focused on an imaging surface through an imaging lens, which has an automatic focusing means for automatically adjusting a point of focus to focus on a detected face. The photographing method includes: storing discrimination information for discriminating a face; detecting, based on the discrimination information, an image representing a face from images taken through the imaging lens; determining, when the image representing a face is detected, whether or not a photographing condition at the time when the image representing the face is taken satisfies an appropriate photographing condition; and exerting control such that, if it is determined that the photographing condition satisfies the appropriate photographing condition, the automatic focusing means carries out a focusing operation to focus on the face, and if it is determined that the photographing condition of the photographing apparatus does not satisfy the appropriate photographing condition, the automatic focusing means does not carry out the focusing operation.

### BRIEF DESCRIPTION OF THE DRAWINGS

FIG. 1 is a front view of an appearance of a digital camera, which is a photographing apparatus according to an embodiment of the present invention;

FIG. 2 is a rear view of the appearance of the digital camera, which is the photographing apparatus according to the embodiment of the invention;

FIG. 3 is a block diagram illustrating the electrical configuration of the digital camera;

FIG. 4 is a block diagram illustrating the detailed configuration of a face detection processing unit in the block diagram of FIG. 3;

FIG. 5 is a flow chart illustrating the flow of an overall photographing process of the digital camera;

FIG. 6 is a flow chart illustrating steps of a face detection process;

FIG. 7 is a flowchart illustrating steps of a focusing process;

FIG. 8 is a graph plotting focus evaluation values;

FIG. 9 is a flow chart illustrating steps of another focusing process where an area to be focused is limited; and

FIG. 10 is a flow chart illustrating steps of yet another focusing process where a focus adjustment range of an imaging lens is limited.

### DESCRIPTION OF THE PREFERRED EMBODIMENTS

Hereinafter, an embodiment of the present invention will be described in detail with reference to the drawings.

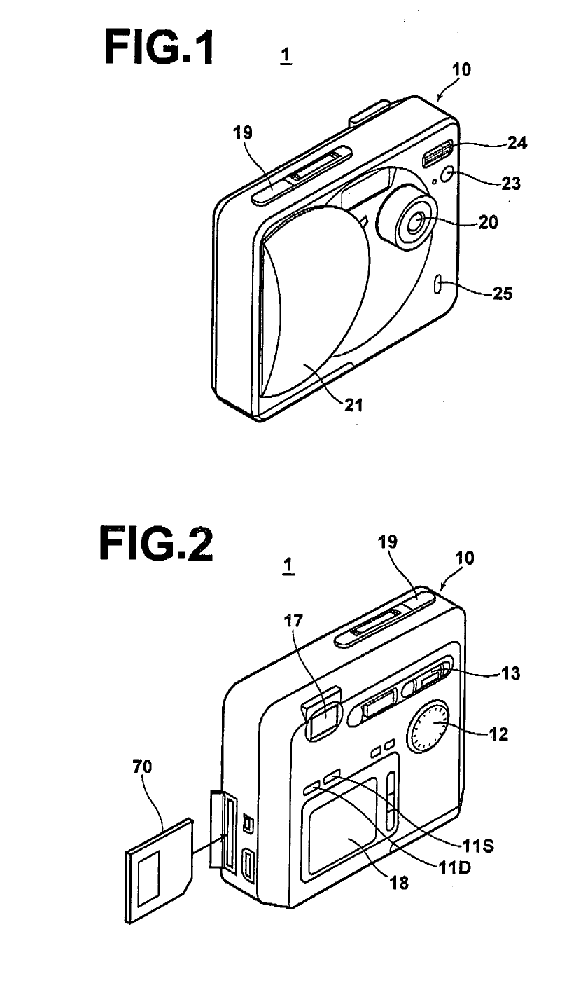

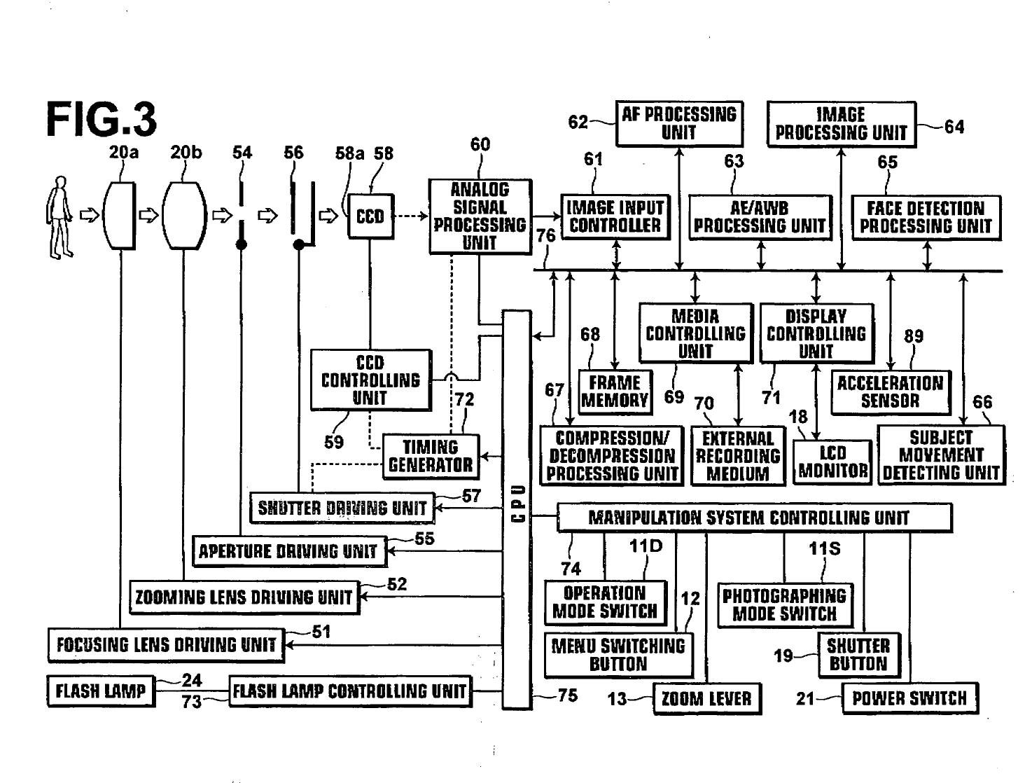

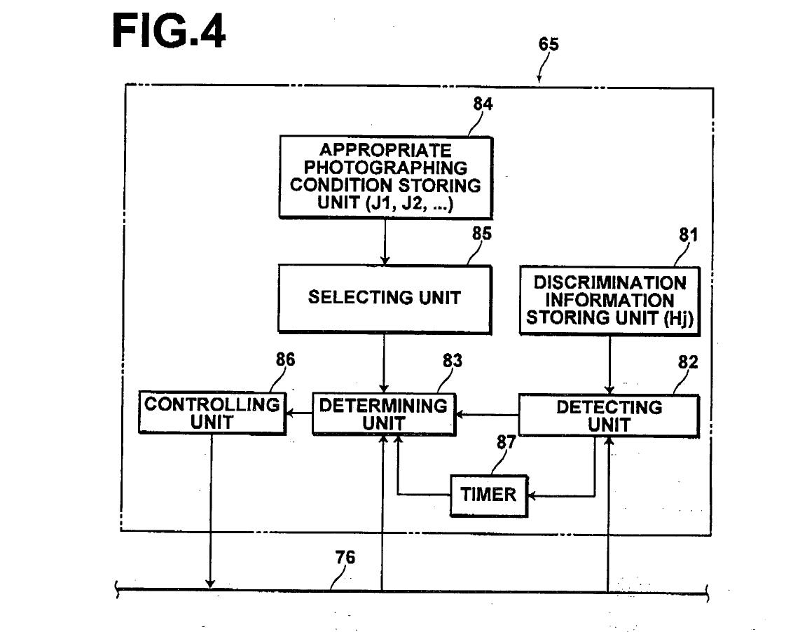

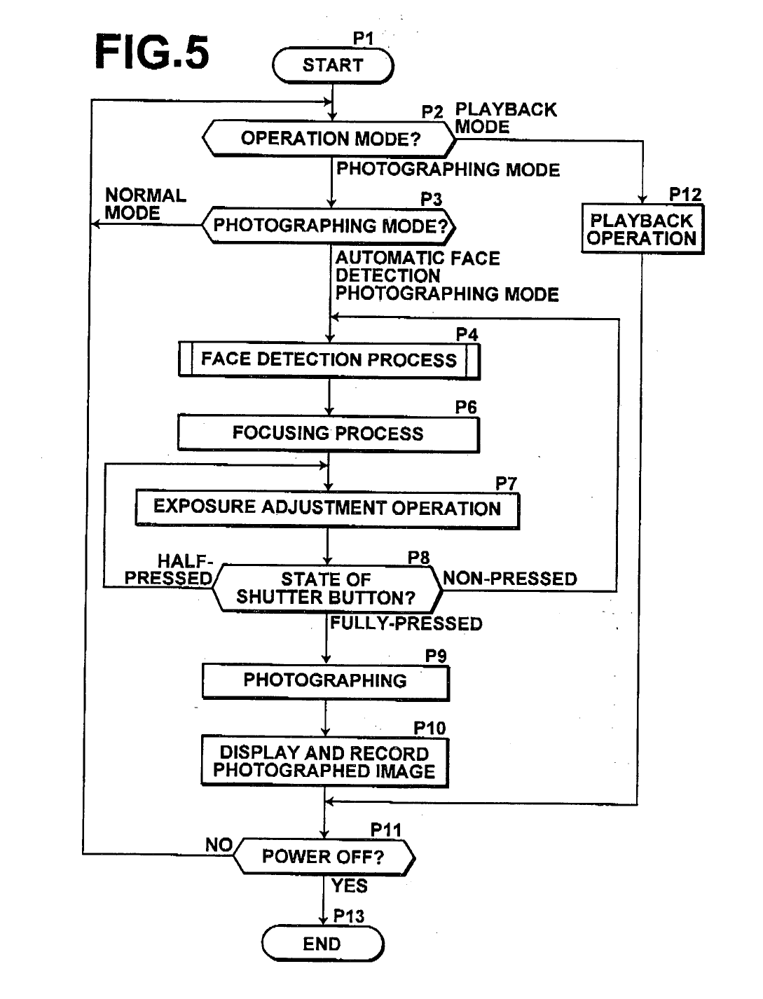

FIGS. 1 and 2 show a digital still camera (hereinafter simply referred to as a “digital camera”), which is one example of a photographing apparatus carrying out a photographing method according to the embodiment of the present invention. FIG. 1 is a front view of the digital still camera, and FIG. 2 is a rear view of the digital still camera. FIG. 3 is a block diagram mainly showing the electrical configuration of the digital camera, FIG. 4 is a block diagram showing details of a face detection processing unit in the above block diagram, and FIG. 5 is a flow chart showing the flow of the overall process carried out in the digital camera.

The digital camera 1 includes an imaging lens 20, which has an automatic focusing unit (described later) for automatically adjusting the point of focus for focusing on a detected face. A subject's image is focused through the imaging lens 20 on an imaging surface 58a, which is a photoelectric conversion surface of a CCD 58, to be photographed. As shown in FIG. 4 for example, the digital camera 1 includes a discrimination information storing unit 81 for storing discrimination information Hj for discriminating a face, a detecting unit 82 for detecting an image representing a face from images taken through the imaging lens 20 based on the discrimination information Hj, a determining unit 83 for determining whether or not a photographing condition of the digital camera 1 at the time when the image representing a face is detected by the detecting unit 82 satisfies an appropriate photographing condition, an appropriate photographing condition storing unit 84 for storing a plurality of appropriate photographing conditions J1, J2, . . . that are candidates for the appropriate photographing condition used for the above determination by the determining unit 83, and a selecting unit 85 for selecting one of the appropriate photographing conditions J1, J2, . . . for use in the above determination.

The digital camera 1 further includes a controlling unit 86, which exerts control such that if it is determined by the determining unit 83 that the photographing condition of the digital camera 1 satisfies the selected appropriate photographing condition, the automatic focusing unit carries out a focusing operation for adjusting the point of focus for focusing on the face, and if it is determined that the photographing condition of the digital camera 1 does not satisfy the appropriate photographing condition, the automatic focusing unit does not carry out the focusing operation.

The discrimination information storing unit 81, the detecting unit 82, the determining unit 83, the appropriate photographing condition storing unit 84, the selecting unit 85, the controlling unit 86, and the like, form a face detection processing unit 65.

The digital camera 1 will be described in more detail below.

As shown in FIG. 2, an operation mode switch 11D, a photographing mode switch 11S, a menu switching button 12 and a zoom lever 13, which serve as an interface for user's manipulation, are provided on the rear side of a body 10 of the digital camera 1. Further, buttons such as a display cursor moving button, a display returning button and a display switching button (which are not shown) are also provided as the interface.

The rear side of the body 10 is further provided with a finder 17 for viewing the subject, a LCD (liquid crystal display) monitor 18 for displaying photographed and played back images, and the like. Furthermore, a shutter button 19 is provided on the top side of the body 10.

As shown in FIG. 1, the front side of the body 10 includes an imaging lens 20, a lens cover 21 that slides in the transverse direction and also serves as a power switch, a finder window 23, a flash lamp 24, a self-timer lamp 25, and the like.

The operation mode switch 11D is a slide switch for switching between operation modes, i.e., a photographing mode and a playback mode, of the digital camera 1. The menu switching button 12 is a button to be pressed or rotated to display, on the LCD monitor 18, various menus for advanced settings of the photographing modes, advanced settings of a light flashing mode, settings of the number of pixels to be recorded, sensitivity, and the like, and to provide selection or setting based on the menu displayed on the LCD monitor 18.

The zoom lever 13 is moved up or down to change the focal length of the imaging lens toward the telephoto side or the wide-angle side.

The display cursor moving button is used for moving a cursor in the menu screen displayed on the LCD monitor 18 for various settings, and the display returning button is used to terminate a current setting operation and return the menu screen to a previous screen. The display switching button is used to switch between ON and OFF of the LCD monitor 18, ON and OFF of various guidance screens, ON and OFF of text display, or the like.

Contents of settings made through user's manipulation of the respective buttons and the lever described above can be visually confirmed, for example, by the display on the LCD monitor 18, by the lamp in the finder and/or by the position of the slide lever. The LCD monitor 18 serves as an electronic view finder by displaying a live view (described later) for viewing the subject during photographing. The LCD monitor 18 also displays a playback view of photographed still images or motion images, as well as various setting menus.

The live view is an image taken at a predetermined time interval and displayed on the LCD monitor 18 without the shutter button being pressed while the photographing mode is selected. The number of pixels forming an image that is taken as the live view is about 1/16 of the number of pixels forming the actually photographed image. The actually photographed image is an image to be recorded, which is acquired when the shutter button is fully pressed to carry out actual photographing. The image data representing the actually photographed image is recorded in an external recording medium 70. The live view and images taken as preliminary images (described later) are not recorded.

As shown in FIGS. 2 and 3, the digital camera 1 converts the image data of the photographed image into an image file of, for example, Exif format, and records the image file in the external recording medium 70 that is attachable to and removable from the body of the digital camera 1. The image file stores image data and associated information.

The digital camera 1 includes a manipulation system controlling unit 74 that serves as an interface for communication between a CPU (central processing unit) 75 and the user who manipulates the switches, such as the operation mode switch 11D, the photographing mode switch 11S, the menu switching button 12, the zoom lever 13, the shutter button 19 and the lens cover 21 that also serves as the power switch, as well as other switches such as the display cursor moving button, the display returning button and the display switching button.

Further, a focusing lens group 20a and a zooming lens group 20b, which form the imaging lens 20, are provided. These lens groups are respectively driven by a focusing lens driving unit 51 and a zooming lens driving unit 52, each of which is formed by a motor and a motor driver, to be moved along the optical axis. The focusing lens driving unit 51 moves the focusing lens group 20a based on focusing lens driving amount data outputted from an AF processing unit 62. The zooming lens driving unit 52 moves the zooming lens group 20b based on data representing an amount of manipulation of the zoom lever 13.

The automatic focusing unit is formed by the focusing lens group 20a, the focusing lens driving unit 51, the AF processing unit 62, the CPU 75, and the like.

An aperture 54 is driven by an aperture driving unit 55 formed by a motor and a motor driver. The aperture driving unit 55 controls the aperture diameter based on aperture value data outputted from an AE (automatic exposure)/AWB (automatic white balance) processing unit 63.

A shutter 56 is a mechanical shutter, which is driven by a shutter driving unit 57 formed by a motor and a motor driver. The shutter driving unit 57 controls opening and closing of the shutter 56 according to a signal generated when the shutter button 19 is pressed and shutter speed data outputted from the AE/AWB processing unit 63.

The CCD 58, which is an image pickup device, is disposed downstream the optical system formed by the focusing lens group 20a, the zooming lens group 20b, the aperture 54, the shutter 56, and the like. The CCD 58 includes an imaging surface 58a formed by a two-dimensional array of a large number of light receiving elements. The light of the subject passing through the optical system is focused onto the imaging surface 58a and subjected to photoelectric conversion. A micro lens array (not shown) for converging the light at each pixel on the imaging surface 58a and a color filter array (not shown) formed by regularly arrayed R, G and B color filters are disposed upstream the imaging surface 58a. The CCD 58 outputs electric charges accumulated at the respective pixels of each line as a serial analog image signal synchronously with a vertical transfer clock and a horizontal transfer clock supplied from a CCD controlling unit 59. A time for accumulating the charges at the pixels, i.e., an exposure time, is determined by an electronic shutter driving signal supplied from the CCD controlling unit 59.

The analog image signal outputted from the CCD 58 is inputted to an analog signal processing unit 60. The analog signal processing unit 60 includes a correlation double sampling circuit (CDS) for removing noise from the analog signal, an automatic gain controller (AGC) for controlling a gain of the analog signal, and an A/D converter (ADC) for converting the analog signal into a digital signal. The image data converted into the digital signal is CCD-RAW data which includes R, G and B density values at the individual pixels.

The timing generator 72 generates a timing signal. The timing signal is inputted to the shutter driving unit 57, the CCD controlling unit 59 and the analog signal processing unit 60, thereby synchronizing the manipulation of the shutter button 19 with opening/closing of the shutter 56, transfer of the electric charges of the CCD 58 and processing by the analog signal processing unit 60. A flash lamp controlling unit 73 controls flashing of the flash lamp 24.

An image input controller 61 writes the image data (CCD-RAW data) inputted from the analog signal processing unit 60 in a frame memory 68. The frame memory 68 provides a workspace for various digital image processing (signal processing) applied to the image data, which will be described later. The frame memory 68 is formed, for example, by a SDRAM (Synchronous Dynamic Random Access Memory) that transfers data synchronously with a bus clock signal of a constant frequency.

A display controlling unit 71 causes, for example, the image data stored in the frame memory 68 to be displayed on the LCD monitor 18 as the live view. The display controlling unit 71 converts the image data into a composite signal by combining the luminance (Y) signal and the chromatic (C) signals and outputs the composite signal to the LCD monitor 18.

The AF processing unit 62 and the AE/AWB processing unit 63 determine a photographing condition based on preliminary images. The preliminary images are images acquired for setting a photographing condition. For example, when the shutter button 19 is half pressed, a half-pressed state signal is generated. The half-pressed state signal is detected by the CPU 75, and the CPU 75 causes the CCD 58 to take images of the subject. The data of the images taken at this time is stored in the frame memory 68. It should be noted that the number of pixels forming the preliminary image is the same as the number of pixels forming the live view.

The AF processing unit 62 detects the point of focus at which the image having the maximum contrast is obtained, based on the preliminary images or the live view, and then, outputs the focusing lens driving amount data.

In this embodiment, a passive method is used for detecting the position of the subject. The passive method utilizes the fact that a focused subject in a photographed image has a higher contrast than an unfocused subject. This point will be described in more detail later.

The AE/AWB processing unit 63 measures a brightness of the subject based on the preliminary images, and then determines an aperture value, a shutter speed, and the like, to output the determined aperture value data and shutter speed data (AE), and automatically controls the white balance for photographing the subject (AWB).

The image processing unit 64 applies, to the image data of the actually photographed image that has been acquired by actual photographing, image quality correction processing, such as gamma correction, sharpness correction and contrast correction, and YC processing to convert the CCD-RAW data into YC data formed by Y data representing a luminance signal, Cb data representing a blue color-difference signal and Cr data representing a red color-difference signal.

The actually photographed image is an image taken via the CCD 58 by actual photographing that is carried out when the shutter button 19 is fully pressed. The image data of the actually photographed image is stored in the frame memory via the analog signal processing unit 60 and the image input controller 61. The upper limit for the number of pixels forming the actually photographed image is determined by the number of pixels of the CCD 58. The number of pixels of an image to be recorded can be changed by setting, such as fine or normal. On the other hand, the number of pixels forming the live view or the preliminary image is less than the number of pixels forming the actually photographed image. The number of pixels forming the live view or the preliminary image is, for example, about 1/16 of the number of pixels forming the actually photographed image.

A compression/decompression processing unit 67 applies compression processing according to a certain compression format, such as JPEG, to the data of the actually photographed image that has been subjected to the correction and conversion processing by the image processing unit 64, to generate an image file. The image file is associated with a tag that stores associated information based, for example, on the Exif format. In the playback mode, the compression/decompression processing unit 67 reads out the compressed image file from the external recording medium 70, and applies decompression processing to the image file. The decompressed image data is outputted to the LCD monitor 18.

A media controlling unit 69 accesses to the external recording medium 70 and controls writing or reading of the image file.

The CPU 75 control the components on/in the body of the digital camera 1 according to signals from the manipulation system such as the operation mode switch 11D and the various processing units such as the AF processing unit 62. A data bus 76 is connected to the image input controller 61, the various processing units 62 to 67, the frame memory 68, the various controlling units 69 and 71 and the CPU 75. Through the data bus 76, transfer of digital image data, communication and control for setting the photographing condition, and the like, are carried out.

Now, a process controlled by the CPU 75 when an image is taken by the digital camera 1 having the above-described configuration will be described with reference to the flow chart shown in FIG. 5. Basic operations carried out by the AF processing unit 62, the AE/AWB processing unit 63, and the like, are as described above, and therefore, explanation of the operations at the respective units is omitted in the following description unless necessary. Here, the flow of the process controlled by the CPU 75 is mainly described.

As the process starts in step P1, as shown in FIG. 5, first, whether the operation mode is the photographing mode or the playback mode is determined in step P2. If it is determined that the operation mode specified by the operation mode switch 11D is the playback mode, the process proceeds to step P12 to carry out the playback operation. As described above, in the playback operation, the image file is read from the external recording medium 70, and the image represented by the image file is outputted by the LCD monitor 18. When the playback operation is completed, the process proceeds to step P11, which will be described later.

On the other hand, if it is determined in step P2 that the operation mode is the photographing mode, the process proceeds to step P3, where the type of the photographing mode is determined.

If the photographing mode specified by the photographing mode switch 11S is an automatic face detection photographing mode, a face detection process is carried out in step P4. If the photographing mode is a normal mode, the process proceeds to a normal photographing operation without carrying out the face detection process.

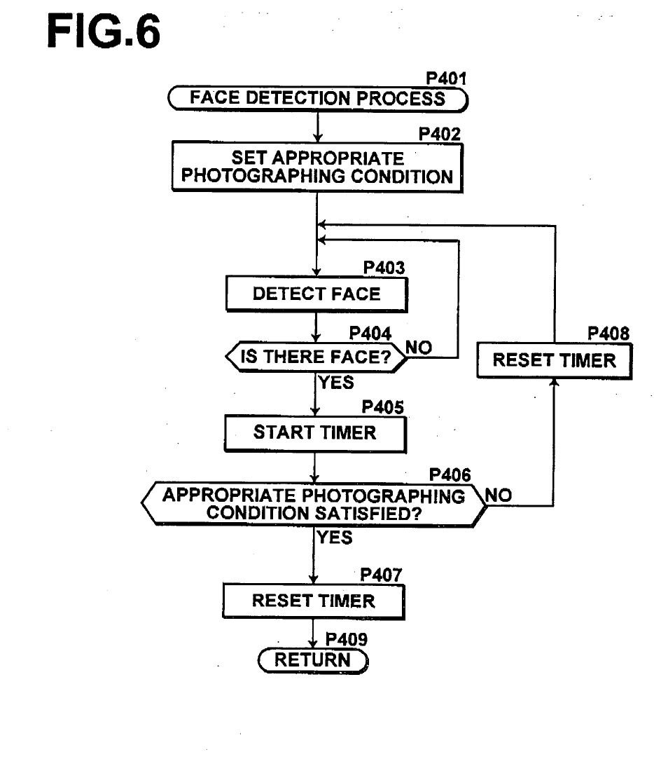

Here, the face detection is described with reference to the block diagram in FIG. 4 illustrating details of the face detection processing unit, and the flow chart in FIG. 6 illustrating details of the face detection process.

In this face detection process, even when a face is detected, the automatic focusing unit does not carry out the focusing operation if the photographing condition of the digital camera 1 is not appropriate and it is highly possible that photographing under this photographing condition will not provide a normal image of the subject. The appropriate photographing condition storing unit 84 stores a plurality of appropriate photographing conditions for determining whether or not the photographing condition of the digital camera 1 is appropriate.

The face detection process starts in step P401 of the flow chart shown in FIG. 6, and proceeds to step P402. In step P402, one of the candidate appropriate photographing conditions J1, J2, . . . stored in the appropriate photographing condition storing unit 84 is selected and set to be used.

In order to set the appropriate photographing condition, one (the appropriate photographing condition J1 in this example) of the appropriate photographing condition J1, J2, . . . stored in the appropriate photographing condition storing unit 84 is specified for use in the above-described determination through user's manipulation of the menu switching button 12, which forms a part of the selecting unit 85. Then, the selecting unit 85 selects the appropriate photographing condition J1 from the storing unit 84, and inputs the appropriate photographing condition J1 to the determining unit 83. The selected appropriate photographing condition J1 in this example is that “the position and the size of the image representing a face within images acquired by photographing the face stay unchanged”. Specifically, a state where the position of an image representing a face stays unchanged, as defined in the appropriate photographing condition J1, refers, for example, to that “a state where changes in the positions of pixels representing the boundary of the face, i.e., the contour of the face, on the imaging surface 58a of the CCD 58 is within two pixels per 1/30 second” continues for at least three seconds. Further, a state where the size of the image representing the face stays unchanged, as defined in the appropriate photographing condition J1, refers, for example, to that “a state where changes in the number of pixels forming the face, i.e., the number of pixels within the contour of the face, on the imaging surface 58a of the CCD 58 is within a range of ±5%” continues for at least three seconds.

It should be noted that the number of the appropriate photographing condition for use in the determination by the determining unit 83 is not limited to one, and a combination of two or more appropriate photographing conditions may be used.

Next, the process proceeds to the face detection process in step P403. In step P403, the live view taken through the imaging lens 20 is inputted to the detecting unit 82, and the discrimination information Hj for discriminating a face is inputted from the discrimination information storing unit 81 to the detecting unit 82. Then, the detecting unit 82 detects an image representing a face from the live view based on the discrimination information Hj. The discrimination information Hj includes information of, for example, positional relationships between components of a face such as eye, nose, mouth and ear, or contours of a face. The detecting unit 82 detects a face using image processing for extracting the positional relationships and/or the contours from the live view. The face detection process may use known conventional techniques described, for example, in Japanese Unexamined Patent Publication Nos. 2004-320286 and 2005-242640.

Subsequently, the process proceeds to step P404. If a face is detected by the detecting unit 82, process proceed to step P405 to activate a timer 87. If no face is detected, the process returns to the face detection process in step P403.

In step P405, the timer 87 is activated, and the process proceeds to an operation carried out in steps P406 and P407.

In step P406, the image processing unit 64 extracts positions of pixels forming the major contours of the face on the imaging surface 58a of the CCD 58 at an interval of 1/30 second, and inputs the information thereof to the determining unit 83.

Together with the pixel positions forming the major contour of the face inputted from the image processing unit 64 at an interval of 1/30 second, an elapsed time from the activation of the timer 87 is inputted to the determining unit 83.

The determining unit 83 compares the latest pixel positions inputted from the image processing unit 64 to the previously inputted pixel positions (i.e., the pixel positions inputted 1/30 second earlier than the latest pixel positions), and carries out a first determination for determining whether or not a difference between the pixel positions is two pixels or more. If it is determined that the difference between the pixel positions is two pixels or more, the process proceeds to step P408, where the timer 87 is reset. Then, the process returns to the face detection process in step P403.

On the other hand, if it is determined by the determining unit 83 that the difference between the pixel positions is less than two pixels, then, a second determination is carried out for determining whether or not the elapsed time inputted from the timer 87 to the determining unit 83 is not less than a preset time, for example, three seconds. If it is determined that the elapsed time is less than three seconds, the process returns to the operation of the first determination. On the other hand, if it is determined that the elapsed time is not less than three seconds, then the process proceeds to step P407, where the timer 87 is reset. Subsequently, the process proceeds to step P409, where the process returns to a focusing process in step P6.

In the focusing process in step P6, the AF processing unit 62 is instructed to carry out the AF operation, and the automatic focusing unit carries out the focusing process. The focusing process will be described in detail later.

Whether or not the automatic focusing unit carries out the focusing process is controlled by the controlling unit 86. If it is determined by the determining unit 83 that the photographing condition of the digital camera 1 satisfies the appropriate photographing condition J1, the controlling unit 86 controls the automatic focusing unit to carry out the focusing process. On the other hand, if it is determined by the determining unit 83 that the photographing condition of the digital camera 1 does not satisfy the appropriate photographing condition J1, the automatic focusing unit is controlled not to carry out the focusing process.

As the focusing process has been carried out, then, in step P7, the AE/AWB processing unit 63 is instructed to determine the exposure, and the exposure is determined.

As the exposure has been determined, then, in step P8, whether the shutter button 19 is in a fully-pressed state, in a half-pressed state or in a non-pressed state is determined.

If the shutter button 19 is in the non-pressed state, i.e., not in the fully pressed or the half-pressed state, then, the process returns to step P4, where the face detection process is carried out again.

If it is determined that the shutter button 19 is in the half-pressed state, then, the exposure adjustment operation is carried out again in step P7.

If it is determined that shutter button 19 is in the fully-pressed state, then, the process proceeds to step P9, where actual photographing of the subject is carried out.

As the actual photographing has been carried out in step P9, the image taken by the actual photographing is displayed on the LCD monitor 18, and the image is recorded in the external recording medium 70 in step P10. Subsequently, in step P11, whether or not the lens cover 21 has been closed and the power has been turned off is determined. If the power is not turned off, the process returns to step P2 and operations for photographing the next subject begin. If the power has been turned off, then, the process proceeds to step P13, where the entire process ends.

According to the above-described embodiment, an amount of processing in the automatic focusing operation for automatically focusing on a detected face for photographing the face can be reduced, thereby reducing power consumption by the automatic focusing operation.

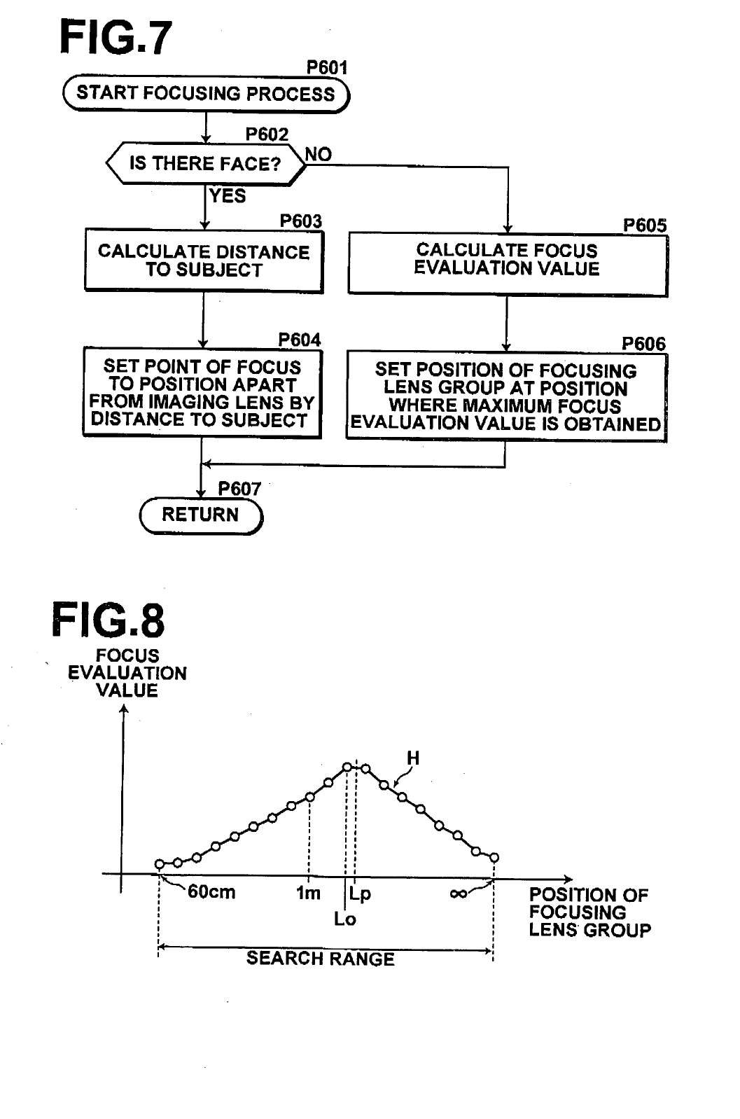

Now, the focusing process carried out by the AF processing unit 62 in step P6 will be described with reference to FIG. 7 illustrating details of the process in step P6.

The focusing process starts in step P601.

In step P602, whether there is a face or not is determined. In this step, if a face has been detected in step P404 described above, it is determined that there is a face. On the other hand, if no face has been detected in step P404, it is determined that there is no face.

If it is determined in step P602 that there is a face, the process proceeds to an operation carried out in steps P603 to P604, where a distance to the subject is calculated and the subject is focused. Details of this operation are as follows.

In step P603, the AF processing unit 62 calculates a distance from the imaging lens to the face, which is the detected subject. The distance to the subject is calculated using the image data representing the preliminary images stored in the frame memory 68. For example, the number of pixels on the CCD 58 corresponding to a feature quantity (such as a width and/or a length of the face) of the subject in the image is found, and the distance to the subject is calculated based on the number of pixels. It should be noted that such calculation of the distance to the subject is described in detail in Japanese Unexamined Patent Publication No. 2004-320286, for example, and the method described therein is applicable to this embodiment.

Then, the position of the focusing lens group 20a is set so that the point of focus of the imaging lens 20 is set at the position that is apart from the imaging lens 20 by the distance equal to the distance to the subject. Namely, the focusing lens driving unit 51 moves the focusing lens group 20a to a position where the point of focus is equal to the position that is apart from the imaging lens 20 by the distance equal to the distance to the subject, based on the focusing lens driving amount data outputted from the AF processing unit 62, and holds the focusing lens group 20a at that position.

As the focusing process has been completed as described above, the process proceeds to step P607 to return to step P7.

On the other hand, if it is determined in step P602 that there is no face, then, the process proceeds to an operation in steps P605 to P606, where a focus evaluation value distribution is found based on focus evaluation values obtained at different points of focus, and the point of focus corresponding to the maximum focus evaluation value in the focus evaluation value distribution is employed. Details of this operation are as follows.

In step P605, first, the focusing lens driving unit 51 moves the focusing lens group 20a stepwise throughout the operation range thereof along the optical axis based on driving data outputted from the AF processing unit 62. In this embodiment, the focus operation range (search range) is a range where an object at a distance ranging, for example, from 60 cm at the nearest side to the infinity at the farthest side is focused. While the focusing lens group 20a is moved in this manner, the image data representing the preliminary images is stored in the frame memory 68. This preliminary photographing is carried out while the focusing lens group 20a is moved stepwise in one direction. The AF processing unit 62 obtains the focus evaluation value that corresponds to the contrast of the image taken at each position. To obtain the focus evaluation value, the AF processing unit 62 filters the image data representing each preliminary image to find high-frequency components thereof, and an integral value of absolute values of the high-frequency components is used as the focus evaluation value of the image. FIG. 8 shows one example of a focus evaluation value distribution H of focus evaluation values, which are obtained successively while the point of focus of the imaging lens 20 is moved in one direction (i.e., the focusing lens group 20a is moved in one direction), as described above, plotted with respect to corresponding positions of the focusing lens group 20a (“60 cm”, “1 m”, and “∞” in FIG. 8 are points of focus corresponding to the positions of the focusing lens group).

Then, in step P606, a point of focus that is suitable for the actual photographing is determined. In this step, the AF processing unit 62 finds, using interpolation, for example, a position Lp of the focusing lens group 20a, as shown in FIG. 8, where the peak focus evaluation value is obtained while the point of focus is moved, i.e., the focusing lens group 20a is moved. The position Lp is used as the position of the focusing lens group 20a set for the actual photographing.

It should be noted that, besides determining the position Lp using interpolation or the like, a position having the maximum focus evaluation value among the actually obtained focus evaluation values (the position Lo in the example shown in FIG. 8) may be employed, or if there are two positions having the maximum value, one which is nearer than the other may be employed.

Further, the focusing lens group 20a may not necessarily be moved throughout the operation range thereof. For example, if a “hill-climbing focusing operation” as shown in Japanese Unexamined Patent Publication No. 2004-48446 is employed, the focusing lens group 20a may only be moved within a part of the operation range thereof. In this case, speeding up of the focusing operation can be achieved.

As the focusing process has been completed as described above, the process proceeds to step P607 to return to the exposure adjustment operation in step P7.

It should be noted that, besides the appropriate photographing condition “the position and the size of the image representing a face within images acquired by photographing the face stay unchanged”, appropriate photographing conditions described below may be applied as the appropriate photographing conditions stored in the appropriate photographing condition storing unit 84 and used for the determination. Further, if a combination of two or more appropriate photographing conditions is used for the determination, the determining unit may determine that the photographing condition of the digital camera 1 satisfies the appropriate photographing condition if it satisfies all of the appropriate photographing conditions used for the determination, or if it satisfies one of the appropriate photographing conditions used for the determination. Examples of the appropriate photographing conditions are as follows.

As the appropriate photographing condition, “the angle of view of the imaging lens is fixed” may be employed. In this case, information about the movement of the zooming lens group 20b forming the imaging lens 20 is inputted to the determining unit 83 via the CPU 75. The determining unit 83 determines that the appropriate photographing condition is satisfied if the zooming lens group 20b is judged, based on the movement information, to have not moved for the past three seconds.

Further, as the appropriate photographing condition, “the photographing apparatus is stationary” may be employed. In this case, acceleration information that represents an acceleration measured by an acceleration sensor 89 provided in the digital camera 1 is inputted to the determining unit 83 via the CPU 75. The determining unit 83 determines that the appropriate photographing condition is satisfied if a state where an image taken by the digital camera 1 would not blur is continuing for at least three seconds, which is judged based on the acceleration information.

Furthermore, as the appropriate photographing condition, “an amount of light received on the imaging surface 58a stays unchanged” may be employed. In this case, light amount information, which is obtained by the CCD 58, representing a total amount of light received in a central area (which is 30% of the entire area) of the imaging surface of the CCD 58 is sequentially inputted to the determining unit 83 via the CPU 75. The determining unit 83 determines that the appropriate photographing condition is satisfied if a state where changes in the amount of received light represented by the inputted light amount information is not more than 5% is continuing for at least three seconds.

Moreover, as the appropriate photographing condition, “images taken through the imaging lens have a constant focus evaluation value” may be employed. In this case, focus evaluation value information representing a focus evaluation value obtained without moving the focusing lens group 20a is sequentially inputted to the determining unit 83 via the CPU 75. The determining unit 83 determines that the appropriate photographing condition is satisfied if a state where changes in the focus evaluation value is within a range of ±5% is continuing for at least three seconds, which is judged based on the focus evaluation value information.

In addition, as the appropriate photographing condition, “values representing colors of taken images stay unchanged”, “the photographing mode of the photographing apparatus is set to a face detection mode, a person photographing mode, a self-timer photographing mode or a self-photographing mode”, “an amount of remaining energy accumulated in a battery for driving the automatic focusing unit is not more than a preset threshold value” or “an amount of remaining energy accumulated in a battery for driving the automatic focusing unit is not less than a preset threshold value” may be employed.

It should be noted that the face detection mode, the person photographing mode, the self-timer photographing mode and the self-photographing mode may or may not have mutually exclusive relationship. For example, the face detection mode and the person photographing mode may or may not be simultaneously set and operated.

Further, for example, the person photographing mode and the self-timer photographing mode may or may not be simultaneously set and operated.

It should be noted that the face detection mode is not a photographing mode for the face detection (for detecting a face). A state where the face detection mode is set refers, for example, to a state where an operation or manipulation for enabling the face detection has been carried out.

In addition, the person photographing mode refers to a mode that is suitable for photographing a person as the subject.

In a case where the photographing apparatus includes a subject movement detecting unit 66 (see FIG. 3) that detects movement of the subject and outputs the result of the detection, “the output from the subject movement detecting unit indicates that the position of the subject stays unchanged” may be employed as the appropriate photographing condition. As the subject movement detecting unit 66, for example, an infrared sensor, which is commonly used for security purpose, can be employed.

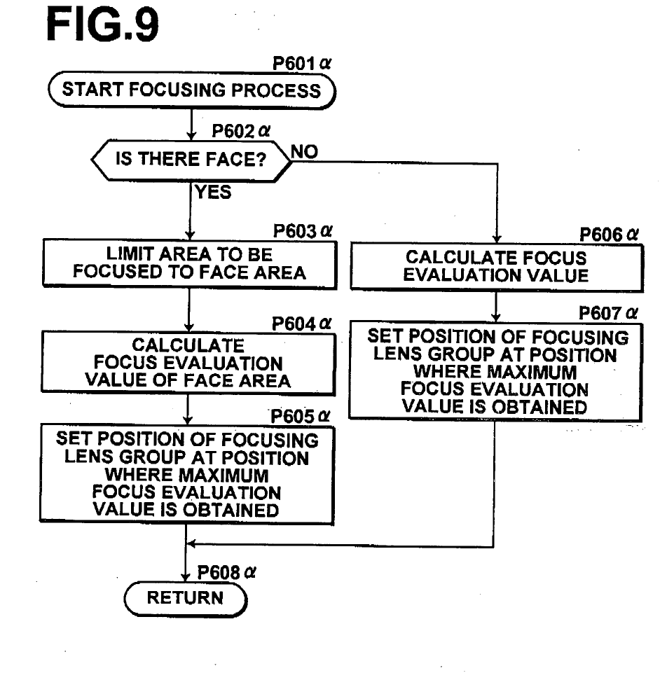

It should be noted that, in stead of the focusing process carried out by the AF processing unit 62 in step P6 described above, another focusing process, in which an area to be focused is limited to the face area, can also be employed. Now, the latter focusing process will be described with reference to FIG. 9. FIG. 9 shows steps P601α to P608α of the focusing process.

The focusing process starts in step P601α.

In step P602α, determination is made as to whether or not there is a face. As explained above, if the face has been detected in step P404, it is determined that there is a face. On the other hand, if no face has been detected in step P404, it is determined that there is no face.

If it is determined in step P602α that there is a face, the process proceeds to an operation carried out in steps P603α to P605α for carrying out the focusing process with the area to be focused being limited to the face area. Details of this operation are as follows.

In step P603α, the area to be focused is limited to the face area by the AF processing unit 62 and the CPU 75.

In step P604α next, the focus evaluation value distribution is obtained based on the focus evaluation values obtained at different points of focus with the area to be focused being limited to the face area. Then, the process proceeds to step P605α.

In step P605α, the focusing lens group 20a is moved to the position corresponding to the maximum focus evaluation value in the focus evaluation value distribution, and is held at that position.

The operations in the steps P604α and P605α are the same as those in steps P605 and P606 described above except that the area to be focused is limited to the face area, and therefore explanation thereof is omitted.

On the other hand, if it is determined in step P602α that there is no face, the focus evaluation value is calculated in step P608β, and the position of the focusing lens group is set to a position at which the maximum focus evaluation value is obtained, in step P609β. That is, without limiting the area to be focused to the face area, the focus evaluation value distribution is obtained, and the focusing lens group 20a is moved to the position corresponding to the maximum focus evaluation value and is held at that position. The operations in the steps P606α and P607α are the same as those in steps P605 and P606 described above, and therefore, are not explained in detail.

As the focusing process has been completed by either of the above-described operations, the process proceeds to step P608β to return to the exposure adjustment operation in step P7.

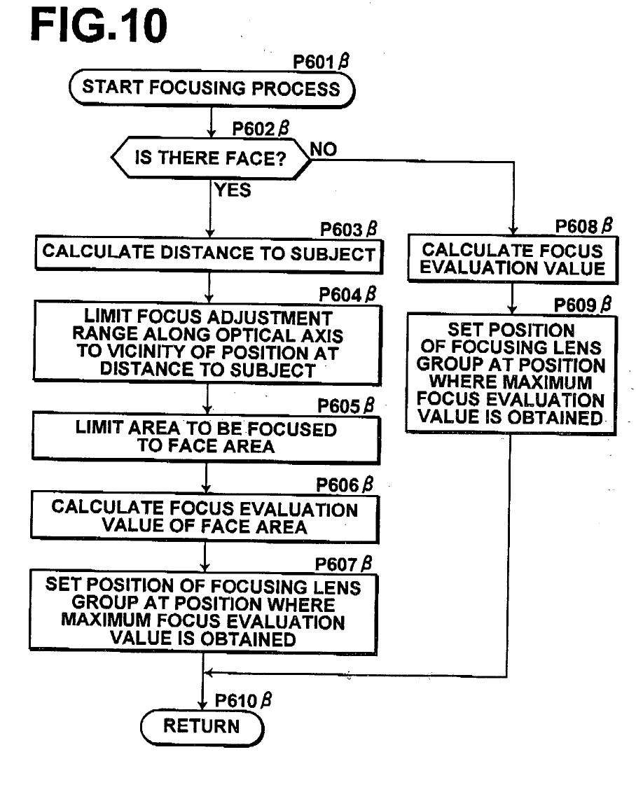

In stead of the focusing process carried out by the AF processing unit 62 in step P6 described above, yet another focusing process, in which the area to be focused and the focus adjustment range of the imaging lens 20 are limited, can also be employed. Now, the latter focusing process will be described with reference FIG. 10. FIG. 10 shows steps P601β to P610β of the focusing process.

The focusing process starts in step P601β.

In step P602β, determination is made as to whether or not there is a face. Similarly to the previously described process, if the face has been detected in step P404, it is determined that there is a face. On the other hand, if no face has been detected in step P404, it is determined that there is no face.

If it is determined in step P602β that there is a face, the process proceeds to an operation carried out in steps P603β to P607β for carrying out the focusing process with the area to be focused and the focus adjustment range of the imaging lens 20 being limited. Details of this operation are as follows.

In step P603β, a distance to the subject, which is a distance from the imaging lens to the face (i.e., the detected subject), is calculated by the AF processing unit 62. Then, the process proceeds to step 604β. The operation in step P603β is the same as that in step P603.

In step 604β, by the operation of the AF processing unit 62 and control by the CPU 75, the focus adjustment range of the imaging lens 20 is limited to a range in the vicinity of a position that is apart from the imaging lens by the above-calculated distance to the subject. The distance to the subject is a distance from the imaging lens 20 to the face. Then, the focusing lens group 20a is moved so that the point of focus of the imaging lens 20 moves within the range in the vicinity of the position that is apart from the imaging lens by the distance to the subject.

In step P605β, the area to be focused is limited to the face area by the operation of the AF processing unit 62 and the CPU 75.

In step P606β next, the focus evaluation value distribution is obtained based on the focus evaluation values obtained at different points of focus with the area to be focused being limited to the face area and the focus adjustment range of the imaging lens 20 being limited to the range in the vicinity of the position that is apart from the imaging lens by the distance to the subject. For this purpose, the focusing lens driving unit 51 moves the focusing lens group 20a within the limited operation range along the optical axis based on the driving data outputted from the AF processing unit 62. As the focusing lens group 20a is moved within the limited operation range (search range), the point of focus is moved within the range in the vicinity of a position that is apart from the imaging lens by the above-calculated distance to the subject. Subsequently, the process proceeds to step P607β.

In step P607β, the focusing lens group 20a is moved to the position corresponding to the maximum focus evaluation value in the focus evaluation value distribution, and held at that position.

The operations in the steps P606β and P607β are the same as those in steps P605 and P606 described above, except that the area to be focused and the focus adjustment range of the imaging lens 20 are limited, and therefore, explanation thereof is omitted.

On the other hand, if it is determined in step P602β that there is no face, the focus evaluation value is calculated in step P608β, and the position of the focusing lens group is set to a position at which the maximum focus evaluation value is obtained, in step P609β. That is, without limiting the area to be focused and the focus adjustment range of the imaging lens 20, the focus evaluation value distribution is obtained, and the focusing lens group 20a is moved to the position corresponding to the maximum focus evaluation value and is held at that position. The operations in the steps P608β and P609β are the same as those in steps P605 and P606 described above, and therefore, detailed explanation thereof is omitted.

As the focusing process has been completed by either of the above-described operations, the process proceeds to step P610β to return to the exposure adjustment operation in step P7.

Although, in the operation carried out in steps P605β to 607β, the position of the focusing lens group at which the maximum focus evaluation value is obtained is found with limiting the area to be focused to the face area, step P605β for limiting the area to be focused to the face area may be omitted. In this case, the operation in steps P606β to 607β may be modified so that the position of the focusing lens group at which the maximum focus evaluation value is obtained is found without limiting the area to be focused to the face area or another particular area.

Although the present invention has been applied to a digital still camera that takes and records still images in the above-described embodiment, the invention is applicable to any photographing apparatuses such as video cameras that take and record motion images, or monitoring cameras that take and record motion images or still images at a predetermined place for a long time.

In the photographing method and device of the invention, an image representing a face is detected from images taken through the imaging lens, and when the image representing a face is detected, whether or not a photographing condition at the time when the image representing the face is taken satisfies the appropriate photographing condition is determined. If it is determined that the photographing condition satisfies the appropriate photographing condition, the automatic focusing means carries out the focusing operation to focus on the face. On the other hand, if it is determined that the photographing condition does not satisfy the appropriate photographing condition, the automatic focusing means does not carry out the focusing operation. Therefore, if the photographing condition is not appropriate and it is highly possible that photographing the subject under this condition will result in a defect image of the subject, in other words, if it is highly possible that the obtained image will blur due to, for example, movement of the hand holding the camera, the automatic focusing means does not carry out the focusing operation even if the face is detected, thereby avoiding unnecessary focusing operation. In this manner, the amount of processing in the automatic focusing operation for automatically focusing on a detected face is reduced, and therefore, power consumption by the automatic focusing operation is reduced.

In a case where the appropriate photographing condition is that the position and the size of the image representing a face within images acquired by photographing the face stay unchanged, that the angle of view of the imaging lens is fixed, that the photographing apparatus is stationary or that images taken through the imaging lens have a constant focus evaluation value, unnecessary automatic focusing operation can be avoided with higher certainty when the photographing condition is not appropriate, and power consumption by the automatic focusing operation can be reduced with higher certainty.

Further, in a case where the photographing apparatus includes a subject movement detecting means for detecting movement of the subject and outputting the result of the detection, and the appropriate photographing condition is that the output from the subject movement detecting means indicates that the position of the subject stays unchanged, the power consumption of the photographing apparatus can further be reduced since the amount of information processing, and therefore the power consumption, by the subject movement detecting means is lower than those by the detecting means for detecting an image representing a face.

What is claimed is:

1. A photographing apparatus for photographing an image of a subject focused on an imaging surface through an imaging lens provided in the photographing apparatus, the imaging lens having an automatic focusing means for automatically adjusting the point of focus to focus on a detected face, the photographing apparatus comprising:
a storing means for storing discrimination information for discriminating a face;
a detecting means for detecting, based on the discrimination information, an image representing a face from images taken through the imaging lens;
a determining means for determining, when the image representing a face is detected by the detecting means, whether or not a photographing condition of the photographing apparatus satisfies an appropriate photographing condition; and
a controlling means for exerting control such that, if it is determined by the determining means that the photographing condition of the photographing apparatus satisfies the appropriate photographing condition, the automatic focusing means carries out a focusing operation to focus on the face, and if it is determined that the photographing condition of the photographing apparatus does not satisfy the appropriate photographing condition, the automatic focusing means does not carry out the focusing operation.

2. The photographing apparatus as claimed in claim 1, wherein the appropriate photographing condition comprises that the position and the size of the image representing a face within images acquired by photographing the face stay unchanged.

3. The photographing apparatus as claimed in claim 1, wherein the appropriate photographing condition comprises that the angle of view of the imaging lens is fixed.

4. The photographing apparatus as claimed in claim 1, wherein the appropriate photographing condition comprises that the photographing apparatus is stationary.

5. The photographing apparatus as claimed in claim 1, wherein the appropriate photographing condition comprises that the images taken through the imaging lens have a constant focus evaluation value.

6. The photographing apparatus as claimed in claim 1, wherein the appropriate photographing condition comprises that an amount of light received on the imaging surface stays unchanged.

7. The photographing apparatus as claimed in claim 1, wherein the appropriate photographing condition comprises that values representing colors of the taken images stay unchanged.

8. The photographing apparatus as claimed in claim 1 further comprising a subject movement detecting means for detecting movement of the subject and outputting the result of the detection,
wherein the appropriate photographing condition comprises that the output from the subject movement detecting means indicates that the position of the subject stays unchanged.

9. The photographing apparatus as claimed in claim 1, wherein the appropriate photographing condition comprises that a photographing mode of the photographing apparatus is set to one of a face detection mode, a person photographing mode, a self-timer photographing mode and a self-photographing mode.

10. The photographing apparatus as claimed in claim 1, wherein the appropriate photographing condition comprises that an amount of remaining energy accumulated in a battery for driving the automatic focusing means is not more than a preset threshold value.

11. A photographing method for photographing an image of a subject focused on an imaging surface through an imaging lens, the imaging lens having an automatic focusing means for automatically adjusting a point of focus to focus on a detected face, the method comprising:
storing discrimination information for discriminating a face;
detecting, based on the discrimination information, an image representing a face from images taken through the imaging lens;
determining, when the image representing a face is detected, whether or not a photographing condition at the time when the image representing the face is taken satisfies an appropriate photographing condition; and
exerting control such that, if it is determined that the photographing condition satisfies the appropriate photographing condition, the automatic focusing means carries out a focusing operation to focus on the face, and if it is determined that the photographing condition of the photographing apparatus does not satisfy the appropriate photographing condition, the automatic focusing means does not carry out the focusing operation.
